(19) United States
(12) Patent Application Publication
(10) Pub. No.: US 2026/0089124 A1
(43) Pub. Date: Mar. 26, 2026

(54) FPGA DATA TRANSFER OVER NETWORK-ON-CHIP (NOC)

(71) Applicant: XILINX, INC., San Jose, CA (US)

(72) Inventors: Hossein OMIDIAN SAVARBAGHI, San Jose, CA (US); Dinesh D. GAITONDE, Fremont, CA (US)

(21) Appl. No.: 18/896,650

(22) Filed: Sep. 25, 2024

(51) Int. Cl. H04L 49/109; H04L 45/00; H04L 45/60; H04L 49/111

(52) U.S. Cl. CPC H04L 49/109; H04L 45/60; H04L 45/66; H04L 49/111

(57) ABSTRACT

Data transfer over a packet-based network-on-chip (NoC) of an integrated circuit device, including an example in which a first region of programmable logic (PL) serves as a first interface circuit between a first circuit block and a NoC master unit (NMU), to receive first and second data via respective first and second channels of the first circuit block based on a communication protocol of the first circuit block, concatenate the first and second data to provide the concatenated content, and transmit the concatenated content to the NMU. The NoC may route the packets from the NMU to a NoC slave unit (NSU) associated with a second circuit block via a pre-determined route of the NoC that is dedicated to traffic between the first and second circuit blocks. A second region of the PL serves as an interface circuit between the NSU and the second block to unpack the data.

### TECHNICAL FIELD

Examples of the present disclosure generally relate to data transfer over a packet-based network-on-chip (NoC) of an integrated circuit device, such as a field-programmable gate array (FPGA).

### BACKGROUND

An integrated circuit (IC) device may include hardened circuit blocks (i.e., non-configurable/non-programmable and/or fixed function circuit blocks), and a high-bandwidth hardened packet-based network-on-chip (NoC). It may be challenging to interface the hardened circuit blocks to the NoC to permit the hardened circuit blocks to exchange data via the NoC. Where the IC device further includes programmable logic, such as a field-programmable gate array (FPGA) or an application-specific integrated circuit (ASIC), a user may configure the programmable logic as an alternative data path between the hardened circuit blocks. Such an approach, however, reduces the amount of programmable logic available for other functions.

### SUMMARY

Techniques for data transfer over a packet-based network-on-chip (NoC) of an integrated circuit device, such as a field-programmable gate array (FPGA).

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts an integrated circuit, according to an embodiment.

FIG. 2A depicts an integrated circuit in which circuit blocks exchange data via a region of programmable logic.

FIG. 2B depicts the integrated circuit of FIG. 2A in which the circuit blocks exchange data via soft shims in programmable logic and a network-on-chip (NoC), according to an embodiment.

FIG. 3 depicts multiple channels of data and sideband signals exchanged between circuit blocks, according to an embodiment.

FIG. 4 depicts the integrated circuit of FIG. 1, according to an embodiment.

FIG. 5 depicts data and sideband signals provided by the integrated circuit depicted in FIG. 4, according to an embodiment.

FIG. 6 depicts content concatenated by concatenation circuitry of the integrated circuit depicted in FIG. 4, according to an embodiment.

FIG. 7 depicts the integrated circuit of FIG. 1, according to another embodiment.

FIG. 8 depicts the integrated circuit of FIG. 1, according to another embodiment.

FIG. 9 depicts the integrated circuit of FIG. 1, according to another embodiment.

FIG. 10 depicts segmentation and alignment circuitry of the integrated circuit depicted in FIG. 9, according to an embodiment

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe data transfer over a packet-based network-on-chip (NoC) of an integrated circuit device, such as a field-programmable gate array (FPGA).

A field-programmable gate array (FPGA) may be programmed to implement and/or accelerate a computationally intensive application such as machine learning and networking. The application may retrieve data from an external (i.e., off-chip) source via a hardened multi-rate media access controller (MRMAC), which may be designed to transfer high-bandwidth data to another hardened circuit block (e.g., a cryptographic circuit block) of the FPGA.

Programmable logic/fabric of the FPGA may be programmed as a high-bandwidth data path between hardened circuit blocks. However, routing high-bandwidth traffic via programmable logic/fabric is cumbersome and consumes significant regions of the programmable logic/fabric, especially where the circuit blocks are placed physically distant from one another. In many situations, users prefer to reserve the entire programmable logic/fabric of an FPGA for custom logic. Using programmable logic/fabric for data exchange may also restrict placement of user logic (within a programmable fabric) to meet timing requirements.

An FPGA may further include a hardened network-on-chip (NoC) that provides high-bandwidth data transfers. Connecting hardened circuit blocks, such as a MRMAC or a cryptographic circuit block is not a trivial task.

An integrated circuit, as disclosed herein, may include configurable interfaces (i.e., soft shims in programmable logic) that interface between circuit blocks (e.g., hardened circuit blocks) and a NoC (e.g., a hardened NoC). The soft shims may use relatively small regions of programmable logic.

The NoC may provide a fixed/pre-determined dedicated path for the shims.

The shims may be configurable to interface with the respective circuit blocks based on communication protocols of the respective circuit blocks.

The soft shims may be configurable to combine data and selected sideband signals (i.e., treat the sideband signals as data).

The soft shims may be configurable to combine multiple channels of data (and, optionally, associated sideband signals), and to transfer the combined data via a single, fixed/pre-determined, and dedicated path of the NoC. This may be useful to increase usage of available bandwidth of the path.

The soft shims may be configurable to operate in one or more of a variety of modes. One or more of the modes may permit a user to program the shims without disclosing sideband signaling information to a designer, manufacturer, and/or vendor of the integrated circuit.

The soft shims, in combination with a high-bandwidth NoC, may be useful to provide low latency, long distance data transport (e.g., across an IC die or FPGA), via a NoC. A fixed/pre-determined and dedicated NoC path may be useful to ensure fixed/deterministic latency.

The soft shims may use relatively limited regions of programmable logic/fabric, and may thus free-up programmable logic/fabric for other tasks/functions.

The soft shims may increase flexibility in floorplanning (i.e., placement of the circuit blocks). As an example, the soft shims in combination with a high-bandwidth NoC, may permit placement of an accelerator circuit block distant from a data source (e.g., a MAC), without adversely impacting timing.

The soft shims may serve as plugin circuits to provide plug and play connections between a NoC and various circuit blocks (e.g., a MRMAC and a cryptographic circuit block).

The soft shims may be useful for hardened circuit blocks and/or configurable/programmable circuit blocks.

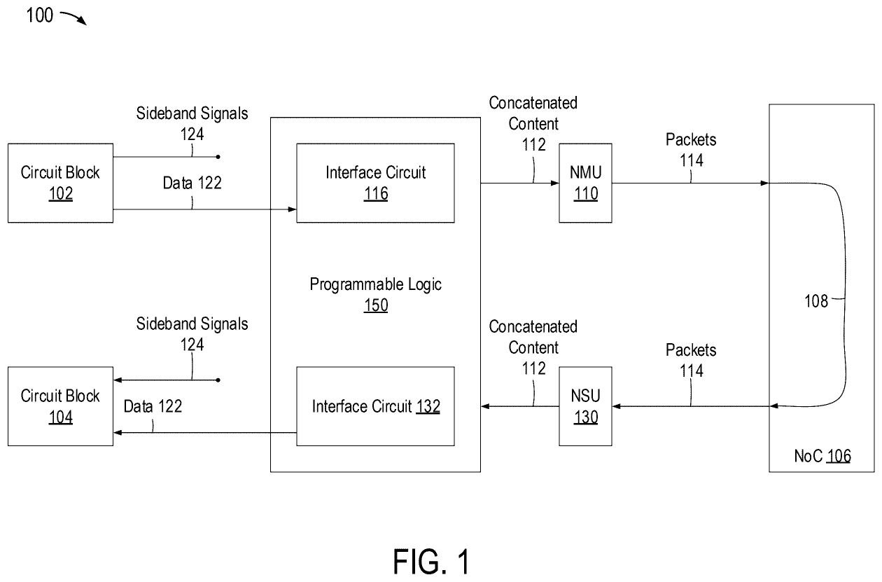

FIG. 1 depicts an integrated circuit (IC) 100 that includes circuit blocks 102 and 104, according to an embodiment. IC 100 may represent or include, for example and without limitation, a field-programmable gate array (FPGA) and/or an application-specific integrated circuit (ASIC). In an example, circuit block 102 includes one or more media access controllers (MACs), which may include multi-rate media access controllers (MRMAC). Circuit block 102 is not, however, limited to a MAC(s).

Circuit block 102 and/or circuit block 104 may include hardened (i.e., fixed hardware/fixed function) circuitry. Alternatively, or additionally, circuit block 102 and/or circuit block 104 may include configurable circuitry and/or programmable circuitry. The term “configurable circuitry” refers to hardened circuitry having selectable options/features. The term “programmable circuitry” refers to programmable logic and programmable interconnects, where the programmable logic may include, for example and without limitation, flip-flops, look-up tables (LUTs), a processor, and/or random-access memory (RAM). Programmable circuitry may also be referred to as programmable logic (PL) and/or programmable fabric.

In the example of FIG. 1, circuit block 102 transmits blocks of data 122 and associated sideband signals 122 to circuit block 122. Sideband signals 122 may include handshake signals (e.g., ready and/or valid signals).

IC 100 further includes a packet-based network-on-chip (NoC) 106 that transmits packets 114 from a NoC master unit (NMU) 106 to a NoC slave unit (NSU) 130. NMU 106 packetizes content 112 to provide packets 114. NSU 130 de-packetizes content 112 from packets 114.

IC 100 further includes shims or interface circuits 116 and 118. Interface circuit 116 interfaces between circuit block 102 and NMU 110. Interface circuit 132 interfaces between NSU 130 and circuit block 104.

Interface circuit 116 receives data 122 from circuit block 102 based on a communication protocol of circuit block 102, and formats or packages data 122 as content 112 based on a communication protocol of NMU 110. Interface circuit 116 may also receive sideband signals 124, and may include selectable ones of sideband signals 124 in content 112.

Interface circuit 116 may be configurable to match the communication protocol of circuit block 102. The communication protocol of circuit block 102 may be a non-standardized and/or proprietary communication protocol. The communication protocol of circuit block 102 is not, however, limited to a non-standardized and/or proprietary communication protocol. Configurable interface circuit 118 may also be configurable for selecting sideband signals 124 to include in content 112.

Interface circuit 116 provides content 112 for NMU 110 based on a communication protocol of NMU 110. Interface circuit 116 may interface with NMU 110 based on sideband signals 126. NMU 110 may generate sideband signals 126 independent of sideband signals 124. Interface circuit 116 may interface with NMU 110 via a point-to-point communication protocol such as, without limitation, an Advanced extensible Interface (AXI) communication protocol.

Interface circuit 132 include a functional mirror image of interface circuit 116. Interface circuit 132 receives content 112 from NSU 130. Interface circuit 132 may interface with NSU 130 via a point-to-point communication protocol such as an AXI protocol.

Interface circuit 132 provides content 112 to circuit block 104 based on a communication protocol of circuit block 104. Where content 112 includes data 122 and sideband signals 124, Interface circuit 132 separates data 122 and sideband signals 124 from one another, and provides data 122 to circuit block 104 based on sideband signals 124. Interface circuit 132 may be configurable to match the communication protocol of circuit block 104. The communication protocol of circuit block 104 may be a non-standardized and/or proprietary communication protocol. The communication protocol of circuit block 104 is not, however, limited to a non-standardized and/or proprietary communication protocol.

NoC 106 may transmit packets 114 from NMU 106 to NSU 130 via a pre-determined or fixed route 108. Route 108 may be dedicated to communications between circuit blocks 102 and 104. In other words, route 108 may be inaccessible to other circuit blocks of IC 100. Route 108 may be determined and dedicated to communications between circuit blocks 102 and 104 by a NoC compiler. A fixed dedicated route may be useful to reduce congestion and/or to ensure consistent/deterministic latency for data transfers between circuit blocks 102 and 104. In examples disclosed further below, IC 100 may concatenate multiple channels of data (and optionally, associated sideband signals), and transmits the concatenated channels over route 108 (e.g., to utilize a full bandwidth of NoC 106).

NoC 106 may transmit packets 114 from NMU 110 to NSU 130 via route 108 without an explicit destination address, which may reduce overhead and/or latency.

As described herein, circuit blocks 102 and 104 exchange data 122 and sideband signals 124 as if circuit blocks 102 and 104 were directly coupled to one another. In other words, circuit block 102 and circuit block 104 appear to communicate directly with one another.

IC 100 may further include an additional NMU, an additional NSU, and additional interface circuits to provide data and/or sideband signals from circuit block 104 to circuit block 102 via NoC 106.

The example of FIG. 1 may be referred to as an unstructured data over dedicated NoC path embodiment.

Circuit block 102 and/or circuit block 104 may include hardened (i.e., fixed hardware/fixed function) circuitry. Alternatively, or additionally, circuit block 102 and/or circuit block 104 may include configurable circuitry and/or programmable circuitry. The term “configurable circuitry” refers to hardened circuitry having selectable options/features. The term “programmable circuitry” refers to programmable logic and programmable interconnects, where the programmable logic may include, for example and without limitation, flip-flops, look-up tables (LUTs), a processor, and/or random-access memory (RAM). Programmable circuitry may also be referred to as programmable logic (PL) and/or programmable fabric.

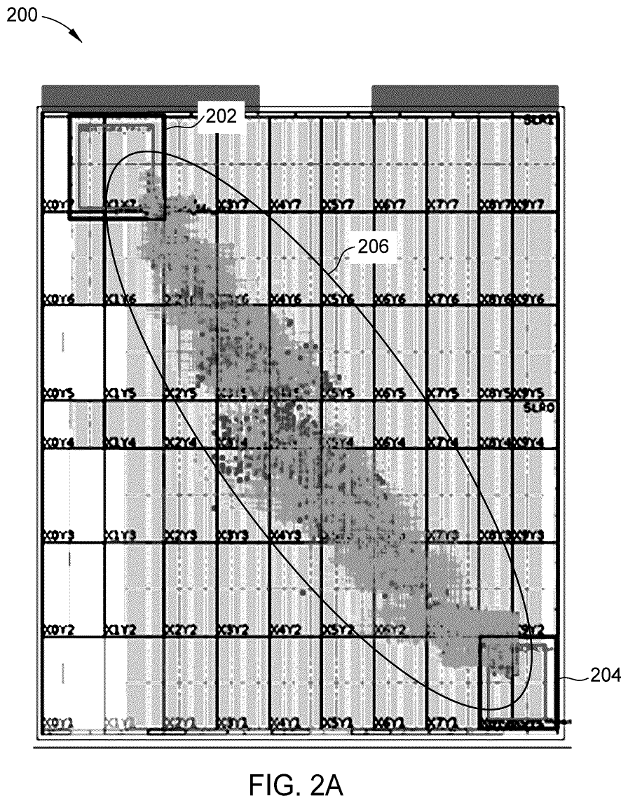

Interface circuit 116 and 132 may be implemented as plugins or soft shims in relatively small regions of configurable and/or programmable logic 150. The relatively small regions of configurable and/or programmable logic may be programmed based on configuration bits stored in configuration random-access memory (CRAM). Some advantages of Interface circuit 116 and 132 are provided below with reference to FIGS. 2A and 2B.

FIG. 2A depicts an IC 200 in which circuit blocks 202 and 204 exchange data via a region 206 of programmable logic, rather than via a NoC. Region 206 encompasses a relatively significant portion of the programmable logic.

FIG. 2B depicts IC 200 in which circuit blocks 202 and 204 exchange data via soft shims 208 and 210 and a NoC, according to an embodiment. As depicted in FIG. 2B, soft shims 208 and 210 occupy relatively limited regions of the programmable logic. In FIG. 2B, region 206 is available for other tasks/functions.

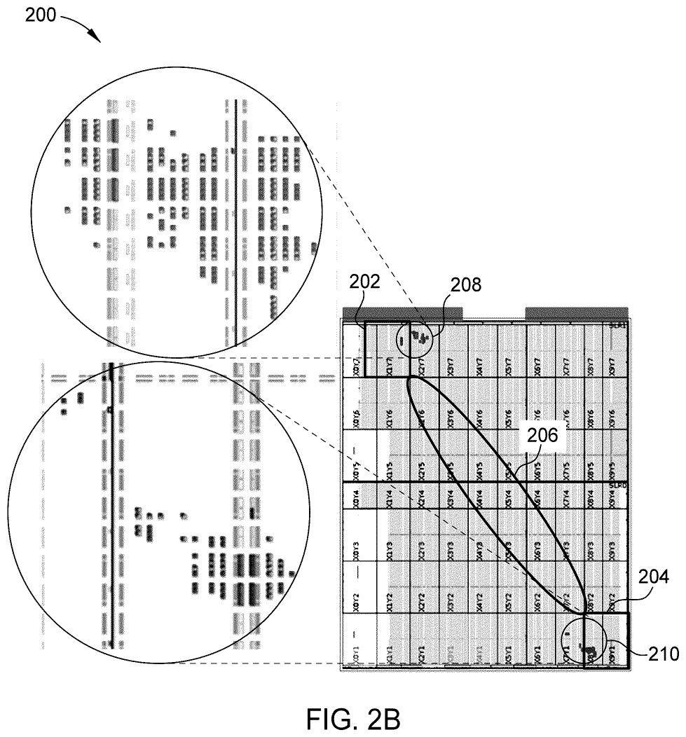

In FIG. 1, interface circuit 116 may receive multiple channels of data and associated sideband signals. FIG. 3 depicts multiple channels of data and sideband signals exchanged between circuit blocks 102 and 104, according to an embodiment. In the example of FIG. 3, the data includes rx_tdata_0 rx_tdata_1. Remaining signals of FIG. 3 represent sideband signals.

In an example, circuit block 102 includes multiple media access controllers (MACs) or a multi-channel MAC. The MAC(s) may include a multi-rate media access controller (MRMAC). Circuit block 102 is not, however, limited to a MAC(s). In an example, a MRMAC may operate in a 40 gigabit Ethernet (i.e., 40GE) mode or a 50 gigabit Ethernet (i.e., 50GE) mode. In the 40GE mode or the 50 GE mode, the MRMAC may operate in a low latency mode or an independent mode, example operating parameters are provided in Table 1, below.

TABLE 1

| | | | Packet | Segmentation | |
|---|---|---|---|---|---|
| Rate | Mode | Clock Freq. | Length | Mode | ? |
| 40GE/ | Low | Same as | 128 | Non- | 3′b000 |
| 50GE | Latency | tx_core_clk | | Segmented | |
| | | rx_core_clk | | | |
| | | (e.g., | | | |
| | | 644,531) | | | |
| | Independent | 322.265 | 256 | Non- | 3′b101 |
| | | | | Segmented | |

Combining multiple channels of data and associated sidebands may result in content 112 exceeding a bus-width (e.g., of a bus within interface circuit 116, between interface circuit 116 and NMU 110, and/or a bus of NoC 106). Techniques to accommodate such situations are provided in examples below.

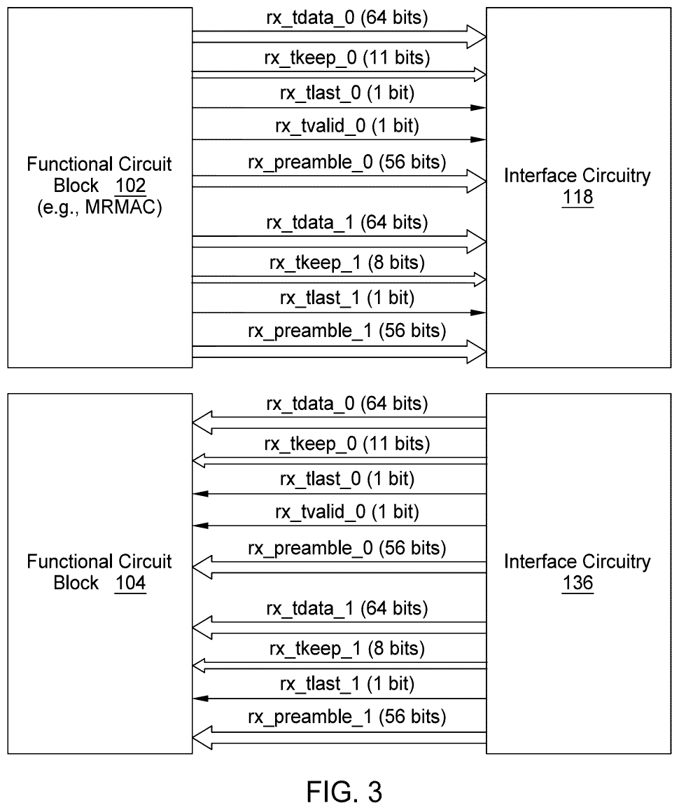

FIG. 4 depicts IC 100, according to an embodiment. In FIG. 4, example bus widths/bit counts are provided in parenthesis. The example embodiment of FIG. 4 is not limited to the example bus widths/bit counts.

In FIG. 4, circuit block 102 outputs multiple channels of data and corresponding sideband signals. A first channel includes data 122-0 (e.g., 256 bits) and sideband signals 124-0 (e.g., 37 bits). A second channel includes data 122-1 (e.g., 256 bits) and sideband signals 124-1 (e.g., 37 bits). In this example, circuit block 102 may represent multiple MRMACs or a multi-channel MRMAC operating in the independent mode of Table 1, running at 50GE, and 322 MHz.

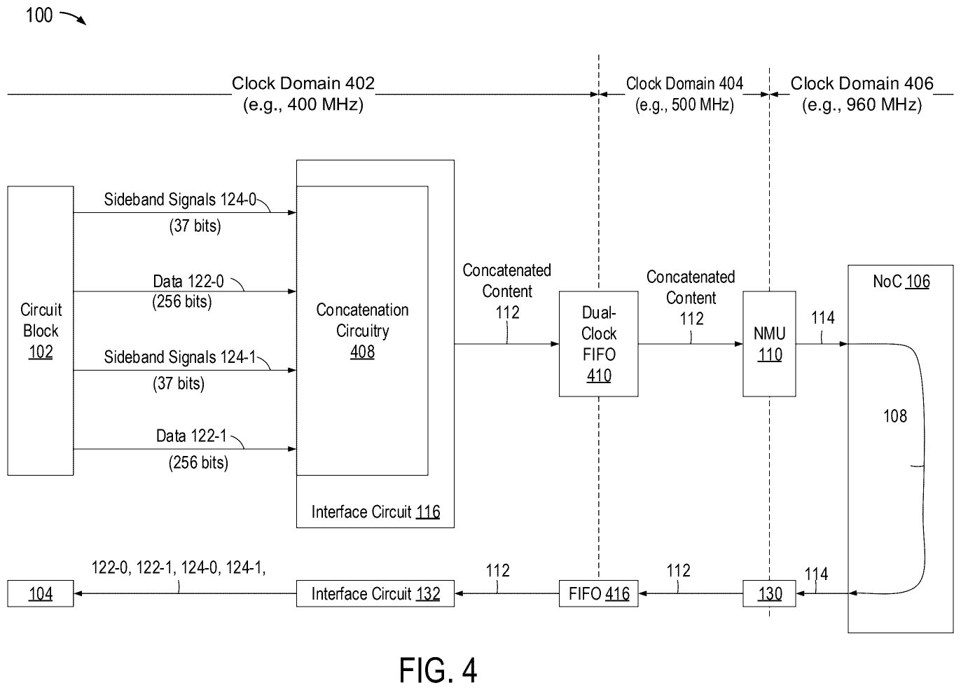

In this example, interface circuit 116 includes concatenation circuitry 408 that concatenates data 122 and sideband signals 124 to provide content 112. Concatenation circuitry 408 may concatenate data 122 and sideband signals 124 to provide content 112 as a configurable-length word and/or a configurable format word. An example is provided further below with reference to FIGS. 5A and 5B. Concatenation circuitry 408 essentially treats data 122 and sideband signals 124 as data. Concatenation circuitry 402 may zero-pad the word with a pre-determined number of bits (e.g., 128 or 256 bits). Configurable interface 118 may append a start field and/or a stop field to the word. In this example, content 112 includes the configurable-length word encapsulated within start and stop fields. Concatenation circuitry 402 may concatenate selectable bits of data 122 and/or sideband signals 124. Configurable interface 136 may include corresponding separator circuitry that separates data 122 and sideband signals 124 from content 112.

In FIG. 4, IC 100 further includes multiple clock domains 402 (e.g., 300 MHz), 404 (e.g., 500 MHz), and 406 (e.g., 960 MHz). In this example, IC 100 further includes a dual-clock first-in-first-out (FIFO) buffer 410 that bridges clock domains 402 and 404, and NMU 110 bridges clock domains 404 and 406. IC 100 may further include a corresponding dual-clock FIFO 416, and Interface circuit 132 may include separator circuitry that separates data 122-0 and 122-1 and sideband signals 124-0 and 124-1 from one another.

The example of FIG. 4 may be useful to increase usage of available bandwidth of route 108 of NoC 106. The example of FIG. 4 may also be useful to permit a user to configure IC 100 without disclosing sideband signaling information to a designer/manufacturer/vendor of IC 100. The example of FIG. 4 may be referred to as a low-latency mode, multi-clock domain, unstructured, multi-channel over dedicated NoC path embodiment of IC 100.

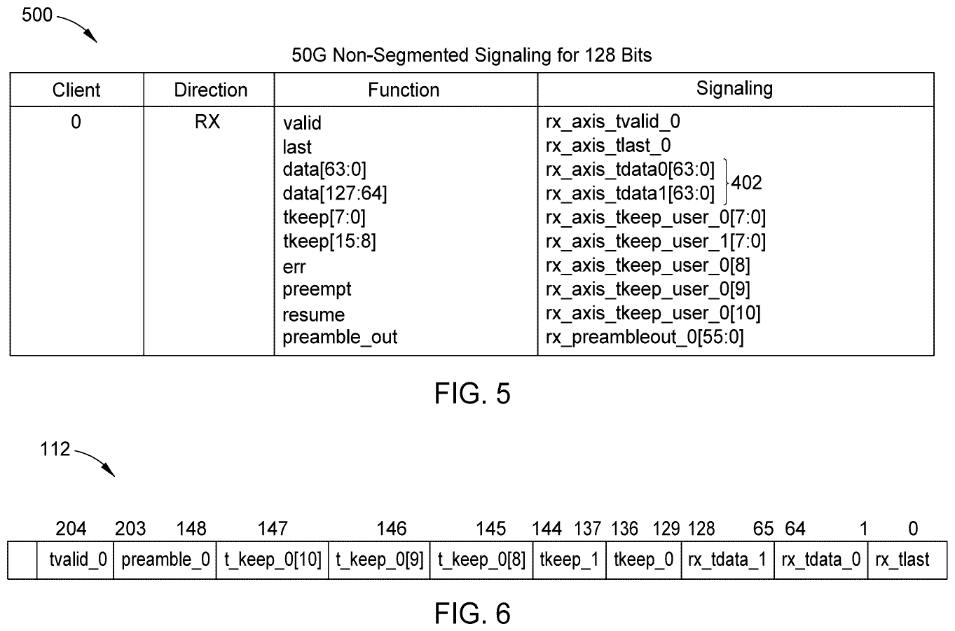

FIG. 5 depicts data and sideband signals 500 provided by circuit block 102, according to an embodiment. FIG. 6 depicts corresponding content 112 concatenated by concatenation circuitry 408, according to an embodiment. Content 112 may be configurable with respect to fields and/or bit-length. In the example of FIG. 6, content 112 is bounded by tvalid_0 and rx_tlast, which may serve as start/stop fields. Concatenation circuitry 408 may zero-pad content 112 to provide a desired number of bits (e.g., 128 or 256 bits).

There may be situations in which concatenated channels of data and sideband signals exceed a bus-width (e.g., a bus between interface circuit 116 and NMU 110 and/or a bus of NoC 106). Techniques to accommodate such situations are disclosed below.

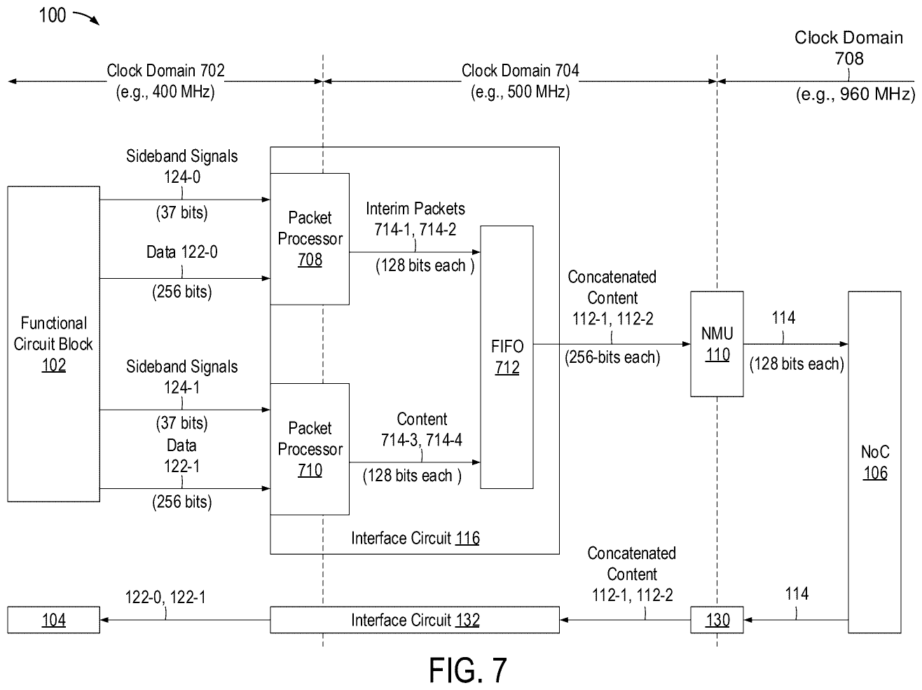

FIG. 7 depicts IC 100, according to an embodiment. In FIG. 7, example bus widths/bit counts are provided in parenthesis. The example embodiment of FIG. 7 is not limited to the example bus widths/bit counts.

In FIG. 7, circuit block 102 outputs multiple channels of data and corresponding sideband signals, such as described further above with respect to FIG. 4. In the example of FIG. 7, circuit block 102 may represent multiple MRMACs or a multi-channel MRMAC operating in the independent mode of Table 1, running at 50GE, and 322 MHz.

In FIG. 7, IC 100 further includes multiple clock domains 702 (e.g., 300 MHz), 704 (e.g., 500 MHz), and 706 (e.g., 960 MHz). Circuit block 102 operates in clock domain 702, and interface circuit 116 includes packet processors 708 and 710 that bridge clock domains 702 and 704.

Packet processor 708 receives a first block of data 122-0 (e.g., 256 bits) based on sideband signals 124-0 (e.g., 37 bits), segments the first block of data 122-0 into first and second segments, associates start and stop fields with the first and second segments to provide first and second interim packets 714-1 and 714-2, (e.g., 128 bits each), and sequentially outputs first and second interim packets 714-1 and 714-2 at a clock rate of clock of second clock domain 708 (e.g., 500 MHz).

Similarly, packet processor 710 receives a second block of data 122-1 (e.g., 256 bits) based on sideband signals 124-1 (e.g., 37 bits), segments the second block of data 122-1 into first and second segments, associates start and stop fields with the first and second segments to provide first and second interim packets 714-3 and 714-4 (e.g., 128 bits each), and sequentially outputs first and second interim packets 714-3 and 714-4 at the clock rate of clock of second clock domain 708.

In FIG. 7, IC 100 further includes a first-in-first-out (FIFO) buffer 712 that concatenates first interim packets 714-1 and 714-1 to provide first concatenated content 112-1, and concatenates second interim packets 714-3 and 714-4 (e.g., 256 bits each) to provide content 112-2, and outputs content 112-1 and 112-2 at the clock rate of second clock domain 701.

In FIG. 7, NMU 100 bridges clock domains 704 and 706. In an example, NMU 100 segments content 112-1 into two internal segments, segments content 112-1 into two internal segments, packetizes the internal segments to provide packets 114 (e.g., 4 packets), and outputs packets 114 at a clock rate of clock domain 708 (e.g., 960 MHz). In this example, NoC 106 operates in clock domain 708.

In FIG. 7, Interface circuit 132 may include a corresponding FIFO buffer and packet processors that separate data 122 and 124 from one another. As described further above, packet processors 706 and 708 receive data 122-0 and 122-1 based on sideband signals 124-0 and 124-1. The packet processors of Interface circuit 132 may provide 122-0 and 122-1 to circuit block 104 based on sideband signals generated by the packet processors of Interface circuit 132. In this example, there is no need to forward sideband signals 124-0 and 124-1 to circuit block 104.

The example of FIG. 7 may be useful for an MRMAC independent mode having a data-width of 256 bits, in which packet-processors 706 and 708 extract and combine two channels of data for transfer via a single route 108 of NoC 106 (e.g., to maximize use of the bandwidth of route 108). The example of FIG. 7 may necessitate a user to provide sideband signaling information to a designer/manufacturer/vendor of IC 100. The example of FIG. 7 may be referred to as a multi-clock domain, packet-processor-based, structured, multi-channel over dedicated NoC path embodiment of IC 100.

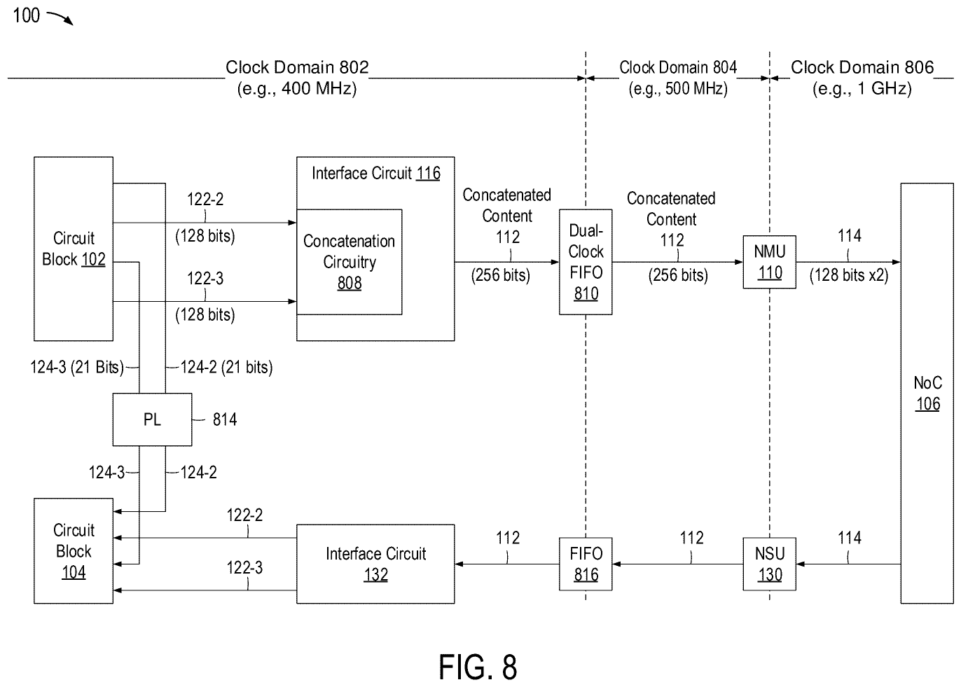

FIG. 8 depicts IC 100, according to another embodiment. Example bus widths/bit counts are provided in parenthesis. The example embodiment of FIG. 8 is not limited to the example bit counts.

In FIG. 8, IC 100 combines multiple channels of data, routes the combined channels of data over the fixed, dedicated route 108 of NoC 106, and routes sideband signals via a relatively small region of programmable logic. The example of FIG. 8 may be useful to permit a user to configure IC 100 to route multiple channels over a single NoC route, without disclosing sideband signaling information a to designer/manufacturer/vendor of IC 100. The example of FIG. 8 may be referred to as a (low-latency mode), PL-sideband, multi-channel over dedicated NoC path embodiment of IC 100.

In FIG. 8, IC 100 includes multiple clock domains 802 (e.g., 300 MHz), 804 (e.g., 500 MHz), and 806 (e.g., 1 GHZ). Circuit block 102 and interface circuit 116 operate in clock domain 802. Circuit block 102 outputs multiple channels of data and corresponding sideband signals. A first channel includes data 122-2 (e.g., 128 bits) and sideband signals 124-2 (e.g., 77 bits, or 21 bits without preambles). A second channel includes data 122-3 (e.g., 128 bits) and sideband signals 124-3 (e.g., 77 bits, or 21 bits without preambles). In this example, circuit block 102 may represent multiple MRMACs or a multi-channel MRMAC operating in the 40GE, low-latency mode of Table 1.

Further in FIG. 8, configurable interface 118 includes concatenation circuitry 808 that combines or concatenates data 122-0 and data 122-1 to provide content 112 (e.g., 256 bits).

Further in FIG. 8, IC 100 includes a dual-clock FIFO 810 that bridges clock domains 802 and 804, and NMU 100 bridges clock domains 804 and 806. In an example, NMU 100 segments content 112 into two internal segments, packetizes the internal segments to provide packets 114 (e.g., 2 packets), and outputs packets 114 at a clock rate of clock domain 808 (e.g., 1 GHZ). In this example, NoC 106 operates in clock domain 808.

Further in FIG. 8, a region 814 of programmable logic is programmed (e.g., via CRAM) to provide/route sideband signals 124-0 and 124-1 from circuit block 102 to circuit block 104. Region 814 may be programmed (e.g., as pipelined stages), such that sideband signals 124-0 and 124-1 arrive at the same time as data 112-2 and 112-3.

IC 100 may further include a corresponding dual-clock FIFO 816, and Interface circuit 132 may include separator circuitry that separates data 112-2 and 112-3 from one another.

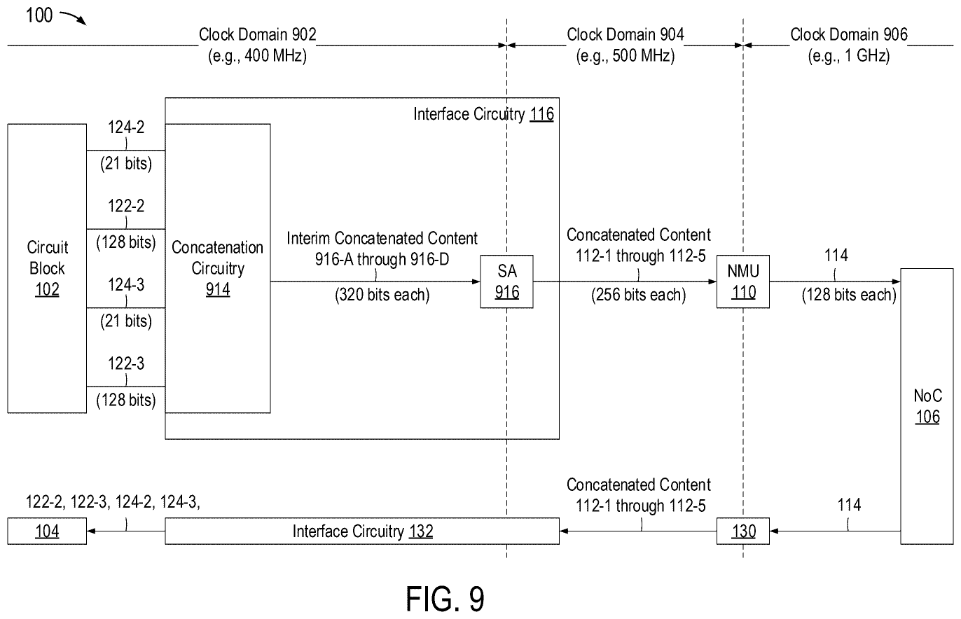

FIG. 9 depicts IC 100, according to another embodiment. Example bus widths/bit counts are provided in parenthesis. The example embodiment of FIG. 9 is not limited to the example bit counts.

In FIG. 9, circuit block 102 outputs multiple channels of data and corresponding sideband signals, such as described above with reference to FIG. 8. In this example, circuit block 102 may represent a multi-channel MRMAC operating in the low-latency mode of Table 1 (e.g., 40GE or 50GE).

In FIG. 9, IC 100 includes multiple clock domains 902 (e.g., 400 MHz), 904 (e.g., 500 MHz), and 906 (e.g., 1 GHZ), and circuit block 102 outputs blocks of data 124-2 and 124-3 at a clock rate of clock domain 902 (e.g., 322 MHz).

Further in FIG. 9, configurable interface 118 includes concatenation circuitry 914 that concatenates a first block of data 124-2 and a first block of data 124-3, and associated sideband signals, to provide a first block of interim concatenated content 916-A (320 bits). Thereafter, concatenation circuitry 914 concatenates subsequent blocks of data 124-2 and 124-3, and associated sideband signals, to provide additional blocks of interim concatenated content 916-B, 916-C, and 916-D.

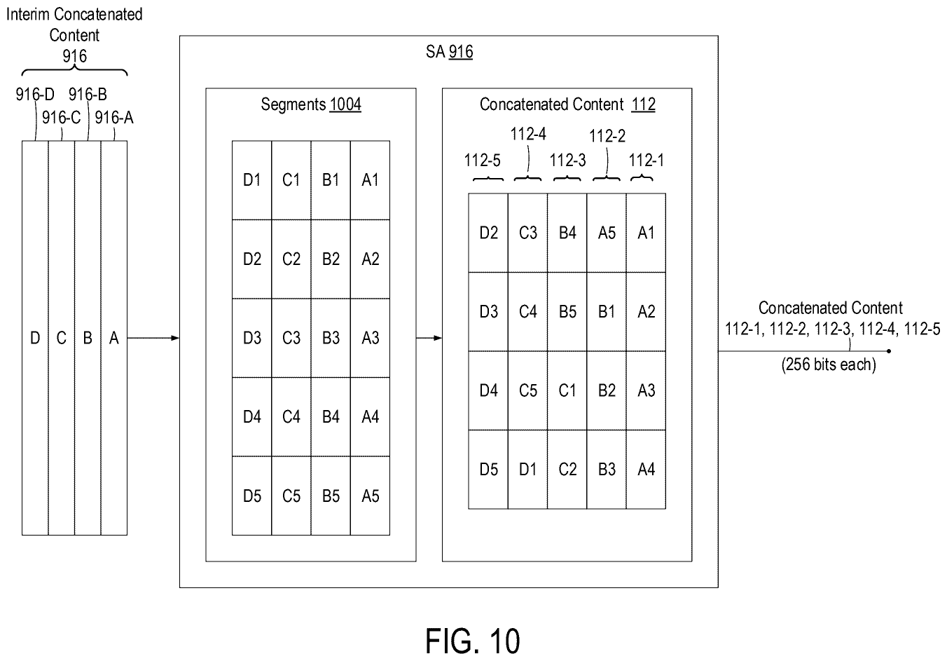

In FIG. 9, interface circuit 116 further includes segmentation and alignment (SA) circuitry 916 that bridges clock domains 904 and 900. SA circuitry 916 segments the blocks of interim concatenated content 916A through 916-D, and re-aligns the segments to provide n-bit blocks of concatenated content 112, where n may represent an output bus-width of SA circuitry 916. An example is provided below with reference to FIG. 10 based on the example bus widths/bits counts of FIG. 9. SA circuitry 916 is not limited to the example bus widths/bit counts of FIG. 9 or the example segmentations of FIG. 10.

FIG. 10 depicts SA circuitry 916, according to an embodiment. In FIG. 10, SA circuitry 916 receives the blocks of interim concatenated content 916A through 916-D based on the clock rate of clock domain 902. SA circuitry 916 segments the block of interim concatenated content 916A into m-bit segments, wherein m is a divisor of n. In an example, n=256 and m=64. In this example, SA circuitry 916 segments the block of concatenated content 916A (e.g., 320 bits) into 5 m-bit (e.g., 64-bit) segments, A1, A2, A3, A4, and A5. SA circuitry 916 segments blocks of concatenated content 916B through 916D in a similar fashion. The segments of the block of concatenated content 916A through 916-D are depicted in FIG. 10 as segments 1004.

SA circuitry 916 aligns subsets of segments 1104 to provide n-bit (e.g., 256-bit) blocks of concatenated content 112. In the example of FIG. 10, SA circuitry 916 aligns subsets of 4 segments 1004, to provide 5 blocks of concatenated content 112-1 through 112-5, each block of concatenated content 112 having n bits (e.g., 256 bits). SA circuitry transmits the blocks of concatenated content 112 to NMU 110 at a clock rate of clock domain 904.

In FIG. 9, NMU 100 bridges clock domains 904 and 906. In an example, NMU 100 segments each block of concatenated content 112-1 through 112-5 into two segments (e.g., into 128-bit segments), packetizes the segments, and outputs the packetized segments as packets 114 at a clock rate of clock domain 908 (e.g., 1 GHZ). In this example, NoC 106 operates in clock domain 908. IC 100 may further include a FIFO buffer between SA circuitry 916 and NMU 110.

Interface circuit 132 may include circuitry that segments content 112-1 through 112-5, re-aligns the segments to provide concatenated blocks 916, and separator circuitry that separates data and sideband signals from concatenated blocks 916.

The example of FIG. 9 may be useful to permit a user to configure IC 100 to route multiple channels over a single NoC route, without disclosing sideband signaling information to a designer/manufacturer/vendor of IC 100. The example of FIG. 9 may be referred to as an optimized (low-latency mode) multi-channel over dedicated NoC path embodiment.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit, comprising:
a packet-based network-on-chip (NoC);
a NoC master unit (NMU) configured to packetize concatenated content and transmit corresponding packets to the NoC; and
programmable logic;
wherein a first region of the programmable logic is configured as a first interface circuit to interface between a first circuit block and the NMU, including to receive first and second data via respective first and second channels of the first circuit block based on a communication protocol of the first circuit block, concatenate the first and second data to provide the concatenated content, and transmit the concatenated content to the NMU; and
wherein the NoC is configured to route the packets from the NMU to a NoC slave unit (NSU) associated with a second circuit block via a pre-determined route of the NoC that is dedicated to traffic between the first and second circuit blocks.

2. The integrated circuit of claim 1, wherein:
the NSU is configured to de-packetize the concatenated content, and wherein the integrated circuit further comprises; and
a second region of programmable logic is configured as a second interface circuit to interface between the NSU and the second circuit block, including to separate the first and second data from the concatenated content, and provide the first and second data to the second circuit block via respective first and second channels of the second circuit block based on a communication protocol of the second circuit block.

3. The integrated circuit of claim 1, wherein:
the first interface circuit is further configured to receive sideband signals associated with the first and second data via the respective first and second channels, and to concatenate the first and second data and selected ones of the sideband signals to provide the concatenated content.

4. The integrated circuit of claim 1, wherein the first interface circuit comprises:
first and second packet processors, each configured to receive a respective one of the first and second data and associated sideband signals based on a first clock rate, segment the respective data into first and second segments, associate start and stop fields with the first and second segments to provide first and second interim packets, and output the first and second interim packets at a second clock rate that is greater than the first clock rate; and
a first-in-first-out (FIFO) buffer configured to concatenate the first interim packets of the first and second packet processors to provide first concatenated content, and concatenate the second interim packets of the first and second packet processors to provide second concatenated content, based on the second clock rate.

5. The integrated circuit of claim 4, wherein:
the NMU is further configured to receive the first and second concatenated content at the second clock rate, segment the first and second concatenated content to provide internal segments, packetize the internal segments to provide the packets, and transmit the packets to the NoC at a third clock rate that is higher than the second clock rate; and
the NoC is further configured to route the packets from the NMU to the NSU via the pre-determined route at the third clock rate.

6. The integrated circuit of claim 1, wherein:
a second region of the programmable logic is configured to transport sideband signals associated with the first and second data from the first circuit block to the second circuit block.

7. The integrated circuit of claim 6, wherein the first circuit block operates based on a first clock rate, and wherein the first interface circuit further comprises:
concatenation circuitry configured to concatenate the first and second data to provide the concatenated content, based on the first clock rate; and
a dual-clock first-in-first-out (FIFO) buffer configured to receive the concatenated content based on the first clock rate and to output the concatenated content based on a second clock rate that is higher than the first clock rate;
wherein the NMU is further configured to receive the concatenated content at the second clock rate, segment the concatenated content into first and second internal segments, packetize the first and second internal segments to provide first and second packets, and transmit the first and second packets to the NoC at a third clock rate that is higher than the second clock rate; and
wherein the NoC is further configured to route the first and second packets from the NMU to the NSU via the pre-determined route at the third clock rate.

8. The integrated circuit of claim 1, wherein the first interface circuit is further configured to receive the first and second data at a first clock rate, and wherein the first interface circuit comprises:
concatenation circuitry configured to concatenate blocks of data and associated sideband signals received via the first channel with corresponding blocks of data and associated sideband signals received via the second channel to provide a sequence of blocks of interim concatenated content; and
segmentation and alignment circuitry configured to segment the blocks of interim concatenated content into m-bit segments, wherein m is a divisor of a bus-width n of an output bus of the segmentation and alignment circuitry, concatenate subsets of the m-bit segments to provide n-bit blocks of the concatenated content, and transmit the n-bit blocks of the concatenated content to the NMU at a second clock rate that is higher than the first clock rate.

9. The integrated circuit of claim 8, wherein:
the NMU is further configured to receive the n-bit blocks of the concatenated content at the second clock rate, segment each of the n-bit blocks of the concatenated content into first and second segments, packetize the first and second segments to provide first and second packets, and transmit the first and second packets to the NoC at a third clock rate that is higher than the second clock rate; and
wherein the NoC is further configured to route the first and second packets from the NMU to the NSU via the pre-determined route at the third clock rate.

10. The integrated circuit of claim 1, wherein the first circuit block comprises first and second media access controllers (MACs).

11. The integrated circuit of claim 10, wherein the MACs comprise multi-rate MACs.

12. The integrated circuit of claim 1, wherein:
the first interface circuit comprises a plugin circuit that is placeable in a selectable region of the programmable logic.

13. A non-transitory computer readable medium encoded with a computer program comprising instructions to cause a processor to:
configure a first region of programmable logic of an integrated circuit to interface between a first circuit block and a network-on-chip master unit (NMU), including to receive first and second data via respective first and second channels of the first circuit block based on a communication protocol of the first circuit block, concatenate the first and second data to provide concatenated content, and transmit the concatenated content to the NMU.

14. The non-transitory computer readable medium of claim 13, wherein:
the integrated circuit comprises a packet-based network-on-chip (NoC);
the NMU is configured to packetize the concatenated content and transmit corresponding packets to the NoC; and
the NoC is configured to route the packets from the NMU to a NoC slave unit (NSU) associated with a second circuit block via a pre-determined route of the NoC that is dedicated to traffic between the first and second circuit blocks.

15. The non-transitory computer readable medium of claim 14, wherein the NSU is configured to de-packetize the concatenated content, further comprising instructions to cause the processor to:
configure a second region of programmable logic to interface between the NSU and the second circuit block, including to separate the first and second data from the concatenated content, and provide the first and second data to the second circuit block via respective first and second channels of the second circuit block based on a communication protocol of the second circuit block.

16. The non-transitory computer readable medium of claim 15, further comprising instructions to cause the processor to:
configure the first region of the programmable logic to receive sideband signals associated with the first and second data via the respective first and second channels, and to concatenate the first and second data and selected ones of the sideband signals to provide the concatenated content.

17. The non-transitory computer readable medium of claim 15, further comprising instructions to cause the processor to:
configure a third region of the programmable logic to transport sideband signals associated with the first and second data from the first circuit block to the second circuit block.

18. A system-on-chip (SoC), comprising:
a packet-based network-on-chip (NoC);
a NoC master unit (NMU) configured to packetize concatenated content and transmit corresponding packets to the NoC; and
programmable logic;
wherein a first region of the programmable logic is configured as a first interface circuit to interface between a first circuit block and the NMU, including to receive content and associated sideband signals from a first circuit block based on a communication protocol of the first circuit block, and concatenate the content and selectable bits of the sideband signals to provide the concatenated content; and
wherein the NoC is configured to route the packets from the NMU to a NoC slave unit (NSU) associated with a second circuit block via a pre-determined route of the NoC that is dedicated to traffic between the first and second circuit blocks.

19. The integrated circuit of claim 18, wherein:
the first interface circuit is further configured to receive first and second data and associated sideband signals via respective first and second channels of the first circuit block based on the communication protocol of the first circuit block, concatenate the first and second data and selectable ones of the sideband signals to provide the concatenated content, and transmit the concatenated content to the NMU.

20. The integrated circuit of claim 18, wherein the first interface circuit crosses multiple clock domains.
